(19) United States
(12) Patent Application Publication
(10) Pub. No.: US 2023/0401429 A1
(43) Pub. Date: Dec. 14, 2023

(54) METHOD AND APPARATUS FOR AUDIO PROCESSING USING A CONVOLUTIONAL NEURAL NETWORK ARCHITECTURE

(71) Applicant: DOLBY LABORATORIES LICENSING CORPORATION, San Francisco, CA (US)

(72) Inventors: Jundai Sun, Beijing (CN); Lie Lu, Dublin, CA (US); Zhiwei Shuang, Beijing (CN)

(73) Assignee: DOLBY LABORATORIES LICENSING CORPORATION, San Francisco, CA (US)

(21) Appl. No.: 18/032,322

(22) PCT Filed: Oct. 19, 2021
(86) PCT No.: PCT/US2021/055672

§ 371 Date: Apr. 17, 2023

Related U.S. Application Data
(60) Provisional application No. 63/112,220, filed on Nov. 11, 2020.

(30) Foreign Application Priority Data
Oct. 19, 2020 (WO) PCT/CN2020/121829
Dec. 3, 2020 (EP) 20211501.0

(51) Int. Cl. G06N 3/0464; G10L 21/00

(52) U.S. Cl. CPC G06N 3/0464; G10L 21/00

(57) ABSTRACT

Systems, methods, and computer program products for audio processing based on convolutional neural network (CNN) are described. A first CNN architecture may comprise a contracting path of a U-net, a multi-scale CNN, and an expansive path of a U-net. The contracting path may comprise a first encoding layer and may be configured to generate an output representation of the contracting path. The multi-scale CNN may be configured to generate, based on the output representation of the contracting path, an intermediate representation. The multi-scale CNN may comprise at least two parallel convolution paths. The expansive path may comprise a first decoding layer and may be configured to generate a final representation based on the intermediate representation generated by the multi-scale CNN. Within a second CNN architecture, the first encoding layer may comprise a first multi-scale CNN with at least two parallel convolution paths, and the first decoding layer may comprise a second multi-scale CNN with at least two parallel convolution paths.

### CROSS-REFERENCE TO RELATED APPLICATION

This application claims priority of the following priority application: PCT international application PCT/CN2020/121829, filed 19 Oct. 2020 and U.S. provisional application 63/112,220, 11 Nov. 2020 and EP application 20211501.0, filed Dec. 3, 2020.

### TECHNOLOGY

The present disclosure relates generally to a method and apparatus for audio processing using a Convolutional Neural Network (CNN). More specifically, the present disclosure relates to extraction of speech from original noisy speech signals using a U-net-based CNN architecture.

While some embodiments will be described herein with particular reference to that disclosure, it will be appreciated that the present disclosure is not limited to such a field of use and is applicable in broader contexts.

### BACKGROUND

Any discussion of the background art throughout the disclosure should in no way be considered as an admission that such art is widely known or forms part of common general knowledge in the field.

Deep neural networks (DNNs) have emerged as a viable option for solving various kinds of audio processing problems. Types of DNNs include feedforward multilayer perceptrons (MLP), convolutional neural networks (CNNs), recurrent neural networks (RNNs), and generative adversarial networks (GANs). Among these, CNNs are a class of feedforward networks.

The U-Net architecture [O. Ronneberger, P. Fischer, and T. Brox, “U-net: Convolutional networks for biomedical image segmentation,” in International Conference on Medical image computing and computer-assisted intervention. Springer, 2015, pp. 234-241] was introduced in biomedical imaging, to improve precision and localization of microscopic images of neuronal structures. The architecture builds upon a stack of convolutional layers as shown in FIG. 1. Each down-sampling layer 11, 12, 13 halves the size of the image and doubles the number of channels. Thus, the image is encoded into a small (fewer-dimensional) and deep representation. The encoded latent features are then decoded to the original size of the image by a stack of up-sampling layers 14, 15, 16.

In recent years, the U-Net architecture has been adopted to the area of audio processing by regarding the audio spectrum as an image. As a result, it became possible to apply the U-net architecture to various audio processing problems, including vocal separation, speech enhancement and speech source separation. Speech source separation aims at recovering target speech from background interferences and finds many applications in the field of speech and/or audio technologies. In this context, speech source separation is also commonly known as the “cocktail party problem”. Challenges arise in this scenario in the extraction of dialog from professional content such as, for example, movie and TV due to the complex background.

It is an object of the present document to provide a novel U-net based CNN architecture which may be applied to various fields of audio processing, including vocal separation, speech enhancement and speech source separation.

### SUMMARY

In accordance with a first aspect of the present disclosure, a convolutional neural network (CNN) architecture is provided. The CNN architecture may be implemented by a computing system, for example. The CNN architecture may comprise a contracting path of a U-net, a multi-scale CNN, and an expansive path of a U-net. The contracting path may comprise a first encoding layer and may be configured to generate an output representation of the contracting path. The multi-scale CNN may be configured to generate, based on the output representation of the contracting path, an intermediate representation. The multi-scale CNN may comprise at least two parallel convolution paths. The expansive path may comprise a first decoding layer and may be configured to generate a final representation based on the intermediate representation generated by the multi-scale CNN.

The proposed CNN architecture may be suitable for or used for audio processing. As such, it may receive a first audio signal (first audio sample) as an input to the contracting path, and output a second audio signal (second audio sample) from the expansive path.

The first encoding layer may be configured to perform a convolution and a down-sampling operation. The first encoding layer may be configured to forward a result of said convolution and down-sampling operation as the intermediate representation to the multi-scale CNN. The first audio signal may be applied directly to the first encoding layer in case the contracting path does not comprise any further encoding layers.

The first decoding layer may be configured to generate an output by receiving the intermediate representation generated by the multi-scale CNN, receiving an output of the first encoding layer, concatenating the intermediate representation and the output of the first encoding layer, performing a convolution operation, and performing an up-sampling operation. The expansive path may be configured to generate the final representation based on said output of the first decoding layer. In particular, the expansive path may be configured to directly use said output of the first decoding layer as the final representation if the expansive path only comprises one (i.e. the first) decoding layer.

The CNN architecture may further comprise a second encoding layer. The second encoding layer may be configured to perform a convolution, perform a down-sampling operation, and forward a result to the first encoding layer. Moreover, the CNN architecture may further comprise a second decoding layer. The second decoding layer may be configured to receive the output of the first decoding layer, receive an output of the second encoding layer, concatenate the output of the first decoding layer and the output of the second encoding layer, perform a convolution operation, and perform an up-sampling operation.

In general, the contracting path may comprise further encoding layers and the expansive path may comprise further counterpart decoding layers which have the same size. In other words, encoding and decoding layers may be added pairwise. For example, additional encoding layers may be added before the second encoding layer for pre-processing an input of the second encoding layer, and additional decoding layers may be added after the second decoding layer for post-processing the output of the second decoding layer. Alternatively, additional layers may be added between the first encoding layer and the second encoding layer, and between the first decoding layer and the second decoding layer, respectively.

The multi-scale CNN may be configured to generate an aggregated output based on outputs of the at least two parallel convolution paths. The multi-scale CNN may be configured to generate the aggregated output by concatenating or adding the outputs of the at least two parallel convolution paths. The multi-scale CNN may be configured to weight the outputs of the at least two parallel convolution path using different weights. In particular, the multi-scale CNN may be configured to weight the outputs of the at least two parallel convolution paths before concatenating or adding said outputs. The weights may be based on trainable parameters learned from a training process.

Each parallel convolution path of the multi-scale CNN may include L convolution layers, wherein L is a natural number>1, and wherein an 1-th layer among the L layers has N1 filters with 1=1 . . . L.

For each parallel convolution path, the number N1 of filters in the 1-th layer may be increasing with increasing layer number 1. For example, for each parallel convolution path, the number N1 of filters in the 1-th layer may be given by N1=1*N0, wherein N0 is a predetermined constant>1. On the one hand, a filter size of the filters may be the same within each parallel convolution path. On the other hand, a filter size of the filters may be different between different parallel convolution paths.

For a given parallel convolution path, the filters of at least one of the layers of the parallel convolution path may be dilated 2D convolutional filters. The dilation operation of the filters of the at least one of the layers of the parallel convolution path may be performed on the frequency axis only.

For a given parallel convolution path, the filters of two or more of the layers of the parallel convolution path may be dilated 2D convolutional filters, and a dilation factor of the dilated 2D convolutional filters may increase exponentially with increasing layer number 1. For example, for a given parallel convolution path, a dilation may be (1,1) in a first of the L convolution layers, the dilation may be (1,2) in a second of the L convolution layers, the dilation may be (1,2\hat{ }(1-1)) in the 1-th of the L convolution layers, and the dilation may be (1,2\hat{ }(L-1)) in the last of the L convolution layers, where (c,d) indicates a dilation factor of c along the time axis and a dilation factor of d along the frequency axis.

Moreover, the multi-scale CNN may comprise a complex convolutional layer with a first CNN, a second CNN, an adding unit, and a subtracting unit. The first CNN may be configured to generate a first and a second intermediate representation based on a real part and an imaginary part of an input signal. The second CNN may be configured to generate a third and a fourth intermediate representation based on the real part and the imaginary part of the input signal. The adding unit may be configured to generate a real output representation based on the first and the third intermediate representations. The subtracting unit may be configured generate an imaginary output representation based on the second and the fourth intermediate representations.

In accordance with a second aspect of the present disclosure, there is provided another CNN architecture. Also this CNN architecture may be implemented by a computing system, for example. The CNN architecture may comprise a contracting path of a U-net and an expansive path of a U-net. The contracting path may comprise a first encoding layer and may be configured to generate an output representation of the contracting path. The first encoding layer may comprise a first multi-scale CNN with at least two parallel convolution paths. The expansive path may comprise a first decoding layer and may be configured to generate a final representation based on the output representation of the contracting path. The first decoding layer may comprise a second multi-scale CNN with at least two parallel convolution paths. Again, this CNN architecture may be suitable for or used for audio processing. As such, it may receive a first audio signal (first audio sample) as an input to the contracting path, and output a second audio signal (second audio sample) from the expansive path.

Both the first multi-scale CNN and the second multi-scale CNN may be implemented using the multi-scale CNN described in the foregoing description. In particular, the first multi-scale CNN and the second multi-scale CNN may be based on an identical network structure.

The first encoding layer may be configured to perform a down-sampling (or pooling) operation on the output of the first multi-scale CNN. The first decoding layer may be configured to receive the output representation of the contracting path, receive an output of the first encoding layer, perform a concatenation based on the output of the first encoding layer and the output representation of the contracting path, feed the result to the second multi-scale CNN and perform an up-sampling operation. Thus, the first decoding layer may be configured to determine said final representation.

The contracting path may comprise a second encoding layer, and the expansive path may comprise a corresponding second decoding layer. The second encoding layer may comprise a third multi-scale CNN with at least two parallel convolution paths, and the second decoding layer may comprise a fourth multi-scale CNN with at least two parallel convolution paths. The third and fourth multi-scale CNN may be based on similar or identical networks structures as the first and second multi-scale CNN.

On the one hand, the second encoding layer may be configured to perform a convolution operation using the third multi-scale CNN, perform a down-sampling operation, and forward the result to the first encoding layer. On the other hand, the second decoding layer may be configured to receive an output of the first decoding layer, an output of the second encoding layer, concatenate the output of the first decoding layer and the output of the second encoding layer, perform a convolution operation using the fourth multi-scale CNN, and finally perform an up-sampling operation to obtain the final representation of the expansive path.

The CNN architecture may further comprise another multi-scale CNN coupled between the contracting path and the expansive path, wherein the another multi-scale CNN comprises at least two parallel convolution paths, and is configured to receive and process the output representation of the contracting path. Further, the another multi-scale CNN may be configured to forward its output to the expansive path.

The first multi-scale CNN may be configured to generate an aggregated output based on outputs of the at least two parallel convolution paths, perform a 2D convolution on the aggregated output, and perform a down-sampling or pooling operation based on the result of the 2D convolution.

The second multi-scale CNN may be configured to generate an aggregated output based on outputs of the at least two parallel convolution paths, perform a 2D convolution on the aggregated output, and perform an up-sampling operation based on the result of the 2D convolution.

Again, the first and/or the second multi-scale CNN may be configured to generate the aggregated output by concatenating or adding the outputs of the respective at least two parallel convolution paths. The first and/or the second multi-scale CNN may be configured to weight the outputs of the at least two parallel convolution path using different weights before concatenating or adding said outputs. The weights may be based on trainable parameters learned from a training process.

Each parallel convolution path of the first and/or the second multi-scale CNN may include L convolution layers, wherein L is a natural number>1, and wherein an 1-th layer among the L layers has N1 filters with 1=1 . . . L. For each parallel convolution path, the number N1 of filters in the 1-th layer may be increasing with increasing layer number 1. For example, for each parallel convolution path, the number N1 of filters in the 1-th layer may be given by N1=1*N0, wherein N0 is a predetermined constant>1. A filter size of the filters may be the same within each parallel convolution path. Alternatively, a filter size of the filters may be different between different parallel convolution paths. For a given parallel convolution path, the filters of at least one of the layers of the parallel convolution path may be dilated 2D convolutional filters. The dilation operation of the filters of the at least one of the layers of each parallel convolution path may be performed on the frequency axis only. Specifically, for a given parallel convolution path, the filters of two or more of the layers of the parallel convolution path may be dilated 2D convolutional filters, and a dilation factor of the dilated 2D convolutional filters may increase exponentially with increasing layer number 1.

The first multi-scale CNN or the second multi-scale CNN may comprise a complex convolutional layer. The complex convolutional layer may comprise a first CNN, a second CNN, an adding unit, and a subtracting unit. The first CNN may be configured to generate a first and a second intermediate representation based on a real part and an imaginary part of an input signal. The second CNN may be configured to generate a third and a fourth intermediate representation based on the real part and the imaginary part of the input signal. The adding unit may be configured to generate a real output representation based on the first and the third intermediate representations. The subtracting unit may be configured generate an imaginary output representation based on the second and the fourth intermediate representations.

A complex target range of the complex convolutional layer may be limited by disregarding complex target values whose absolute values are larger than a predetermined threshold value. Alternatively, the complex target range of the complex convolutional layer may be limited by mapping, using a transformation function, complex target values to mapped complex target values whose absolute values are smaller than or equal to a predetermined threshold value.

In accordance with a third aspect of the present disclosure, there is provided an apparatus for audio processing. The apparatus may be configured to receive input of an input audio signal and output an output audio signal. The apparatus may comprise any one of the above-described CNN architectures. An input to the contracting path may be based on the input audio signal and the output audio signal may be based on an output of the expansive path.

In accordance with a fourth aspect of the present disclosure, there is provided a method of audio processing using convolutional neural networks (CNNs). The method may comprise providing a contracting path of a U-net with a first encoding layer. The method may comprise generating, by the contracting path, an output representation of the contracting path. The method may comprise providing a multi-scale CNN comprising at least two parallel convolution paths. The method may comprise generating, by the multi-scale CNN, based on the output representation of the contracting path, an intermediate representation. The method may comprise providing an expansive path of a U-net with a first decoding layer. The method may comprise generating, by the expansive path, a final representation based on the intermediate representation generated by the multi-scale CNN.

In accordance with a fifth aspect of the present disclosure, there is provided another method of audio processing using convolutional neural networks (CNNs). The method may comprise providing a contracting path of a U-net with a first encoding layer, wherein the first encoding layer comprises a first multi-scale CNN with at least two parallel convolution paths. The method may comprise generating, by the contracting path, an output representation of the contracting path. The method may comprise providing an expansive path of a U-net with a first decoding layer, wherein the first decoding layer comprises a second multi-scale CNN with at least two parallel convolution paths. The method may comprise generating, by the expansive path, a final representation based on the output representation of the contracting path.

In accordance with a sixth aspect of the present disclosure, there are provided computer program products, each comprising a computer-readable storage medium with instructions adapted to cause a respective device to carry out some or all of the steps of the above-described methods when executed by a device having processing capability.

According to a seventh aspect of the present disclosure, a computing system implementing the aforementioned CNN architecture(s) is provided.

According to a further aspect of the present disclosure, a system for audio processing is presented. The system may comprise one or more processors and a non-transitory computer-readable medium storing instructions that, when executed by the one or more processors, cause the one or more processors to perform the following operations: receiving an input audio signal and processing the input audio signal using a CNN architecture according to any one of the above-described CNN architectures. The processing may comprise providing an input to the contracting path of the CNN architecture based on the input audio signal, and generating an output audio signal based on an output of the expansive path of the CNN architecture. Furthermore, the system may be configured to provide the audio signal to a downstream device.

### BRIEF DESCRIPTION OF THE DRAWINGS

Example embodiments of the disclosure will now be described, by way of example only, with reference to the accompanying drawings in which:

FIG. 1 illustrates a traditional U-net architecture.

FIG. 2 illustrates a first embodiment of a proposed CNN architecture.

FIG. 3 illustrates an example of an aggregated multi-scale CNN.

FIG. 4 illustrates a more detailed view of the aggregated multi-scale CNN of FIG. 3.

FIG. 5 illustrates a second embodiment of a proposed CNN architecture.

FIG. 6 illustrates an exemplary multi-scale encoding layer.

FIG. 7 illustrates an exemplary multi-scale decoding layer.

FIG. 8 illustrates a further exemplary multi-scale encoding layer.

FIG. 9 illustrates a further exemplary multi-scale decoding layer.

FIG. 10 illustrates an exemplary complex convolutional layer.

### DESCRIPTION OF EXAMPLE EMBODIMENTS

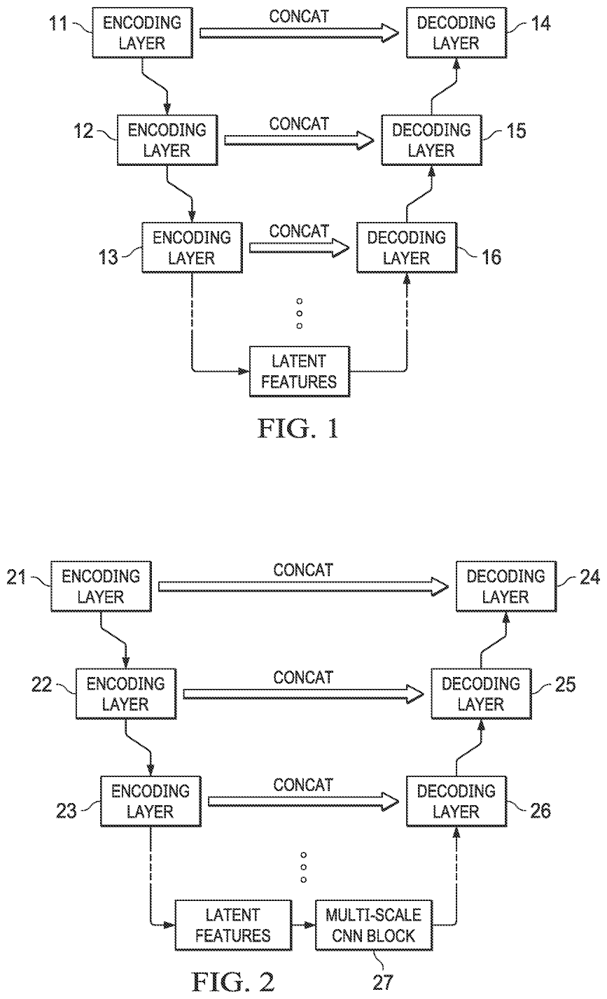

FIG. 1 illustrates a traditional U-net architecture. The U-net architecture builds upon a stack of convolutional layers organized in a contracting path including encoding layers 11, 12, 13 and an expansive path including decoding layers 14, 15, 16. The contracting path follows the typical architecture of a convolutional network. It may consist, in each encoding layer 11, 12, 13, of the repeated application of convolutions, each followed by a rectified linear unit (ReLU) and a max pooling operation with an appropriate stride for down-sampling. At each down-sampling, the number of feature channels may be doubled. Every decoding layer 14, 15, 16 in the expansive path may consist of an up-sampling of the feature map followed by a convolution that halves the number of feature channels, a concatenation with the correspondingly cropped feature map from the contracting path, and further convolutions, each followed by a ReLU.

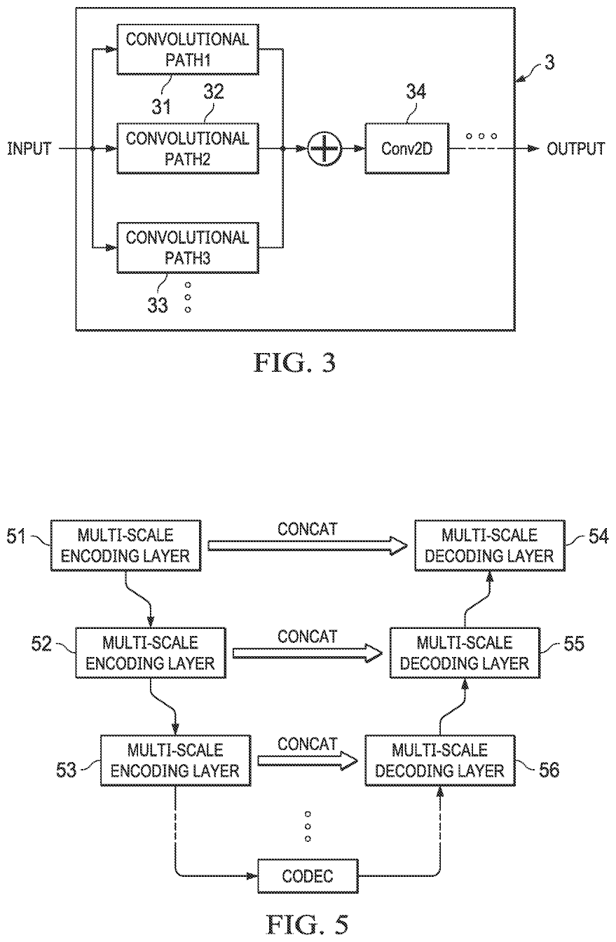

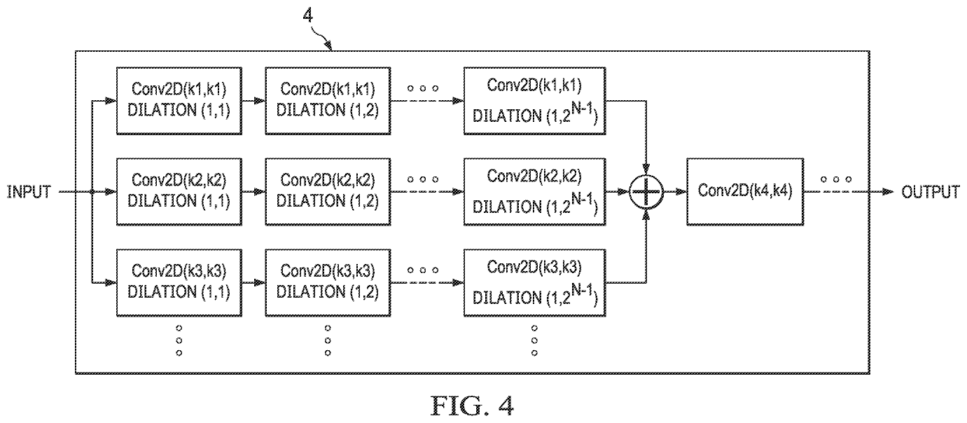

FIG. 2 illustrates a first embodiment of a proposed CNN architecture. In this architecture, the multi-scale CNN block 27 is embedded at the bottleneck layer of U-NET. Compared to original U-NET, the output representation of the encoding layers 21, 22, 23 will be fed into the multi-scale CNN 27. The structure of a potential multi-scale CNN 27 is illustrated in FIGS. 3 and 4. The multi-scale CNN block 27 may not change the feature dimension, but uses several convolutional paths to fully analyse the latent representation in different scales and then aggregates them finally. The output of multi-scale CNN block 27 will be fed to decoding layers 24, 25, 26. In the illustrated first embodiment, the concatenation between the encoding layers and the decoding layers may be the same as in U-net. The proposed CNN architecture may be implemented by a suitable computing system, as the skilled person will appreciate.

In an exemplary implementation, the architecture illustrated in FIG. 2 has been applied to a speech enhancement application for a 48 kHz audio signal. Data has been transformed to the T-F domain by using 4096 short time Fourier transform (STFT) with a 50% overlap. As result, a 2049-point magnitude has been obtained. Subsequently, 8 frames data have been fed to the model by ignoring the direct-current (DC) bin (i.e., the input dimension was 8*2048), and the target was a magnitude ratio mask of 8 frames (i.e., 8*2048). In this example implementation, each encoding layer consisted of a 2D convolution with stride 1 and kernel size 3×3, and a pooling layer with size 1×2. In the encoding path, the feature size was reduced by half at frequency axis and the number of filters was doubled each time. In the decoding path, the feature size was doubled at frequency axis and the number of filters was reduced by half each time.

FIGS. 3 and 4 illustrate examples of aggregated multi-scale CNNs which may be directly used as multi-scale CNN block 27 in FIG. 2. The aggregated multi-scale CNN 3 in FIG. 3 includes a plurality of parallel convolution paths 31, 32, 33. While the number of parallel convolution paths is not limited, the aggregated multi-scale CNN may include three parallel convolution paths. By means of these parallel convolution paths, the extraction of local and general feature information of the time-frequency transform of the multiple frames of the audio signal is possible in different scales. The output of the parallel convolution paths 31, 32, 33 is aggregated and undergoes a further 2D convolution 34.

With the help of the multi-scale CNN block 27 at the bottleneck layer of a U-net, it becomes possible to use different filter sizes combined with different stride or dilation to capture features in different scales. Based on the multi-scale CNN, the network is able to generate scale-relevant features which is very important and cost effective for practical applications. In FIG. 2, each parallel convolution path may use the same filter size. For example, FIG. 2 the three parallel paths may have different kernel sizes. In this way, the model learns the same-scale features in each path, which greatly accelerates the convergence of the model. In each path, an exponentially increasing dilation factors may be applied on the frequency axis. This results in an increasing receptive field, and also works like comb filters and may discover potential harmonic structures/correlations. Meanwhile, we also increase the channel/filter number along the convolutional layers. Using parallel paths with different scales, both local and (relatively) global information may be captured, and features characterizing various shapes of speech harmonics may be extracted. The output from each path is aggregated for further processing. We can either concatenate them or compute a weighted average. Based on pilot experiments, we found that features extracted by different filter sizes have different properties. Using large convolutional filter size tends to preserve more harmonics of speech but also retains more noise, while using smaller filter size preserves only the key components of speech and removes noise more aggressively. Therefore, if we choose a large weight for the path with large filter size, the model will be relatively conservative and have better speech preservation (at the cost of more residual noise). On the other hand, if we choose a larger weight for the path with small filter size, the model will be more aggressive on noise removal and may also lose some speech components. Thus, we can change the weights to control the aggressiveness of the model. We can also design/learn optimal weights based on preferred trade-off in a specific application.

FIG. 4 illustrates a more detailed view of the aggregated multi-scale CNN 4. The time-frequency transform of the multiple frames may be (parallelly) input into the plurality of parallel convolution paths. Each parallel convolution path, out of the plurality of parallel convolution paths of the CNN, may include N convolution layers, wherein N is a natural number>1, and each convolution layer may comprise a certain number of filters.

The filter size of the filters may be the same (i.e., uniform) within each parallel convolution path. For example, a filter size of (k1,k1) (i.e., k1*k1) may be used in each layer within the top parallel convolution path. By using the same filter size in each parallel convolution path, mixing of different scale features may be avoided. In this way, the CNN learns the same scale feature extraction in each path, which greatly improves the convergence speed of the CNN. The filter size of the filters may be different between different parallel convolution paths. For example, without intended limitation, if the aggregated multi-scale CNN includes three parallel convolution paths, the filters size may be (k1,k1) in the first (top) parallel convolution path, (k2,k2) in the second (middle) parallel convolution path, and (k3,k3) in the third (bottom) parallel convolution path. For instance, the filter size may depend on a harmonic length to conduct feature extraction.

The filters of at least one of the layers of the parallel convolution path may be dilated 2D convolutional filters. The use of dilated filters enables extracting the correlation of harmonic features in different receptive fields. Dilation enables to reach far receptive fields by jumping (i.e., skipping, leaping over) a series of time-frequency (TF) bins. The dilation operation of the filters of the at least one of the layers of the parallel convolution path may be performed on the frequency axis only. For example, a dilation of (1,2) in the context of this disclosure may indicate that there is no dilation along the time axis (dilation factor 1), while every other bin in the frequency axis is skipped (dilation factor 2). In general, a dilation of (1,d) may indicate that (d-1) bins are skipped along the frequency axis between bins that are used for the feature extraction by the respective filter.

As illustrated in FIG. 4, for a given convolution path, the filters of two or more of the layers of the parallel convolution path may be dilated 2D convolutional filters, wherein a dilation factor of the dilated 2D convolutional filters increases exponentially with increasing layer number. In this way, an exponential receptive field growth with depth can be achieved. As illustrated in the example of FIG. 4, for a given convolution path, a dilation may be (1,1) in a first of the N convolution layers, the dilation may be (1,2) in a second of the N convolution layers, and the dilation may be (1,2\hat{ }(N-1) in the last of the N convolution layers, where (c,d) indicates a dilation factor of c along the time axis and a dilation factor of d along the frequency axis.

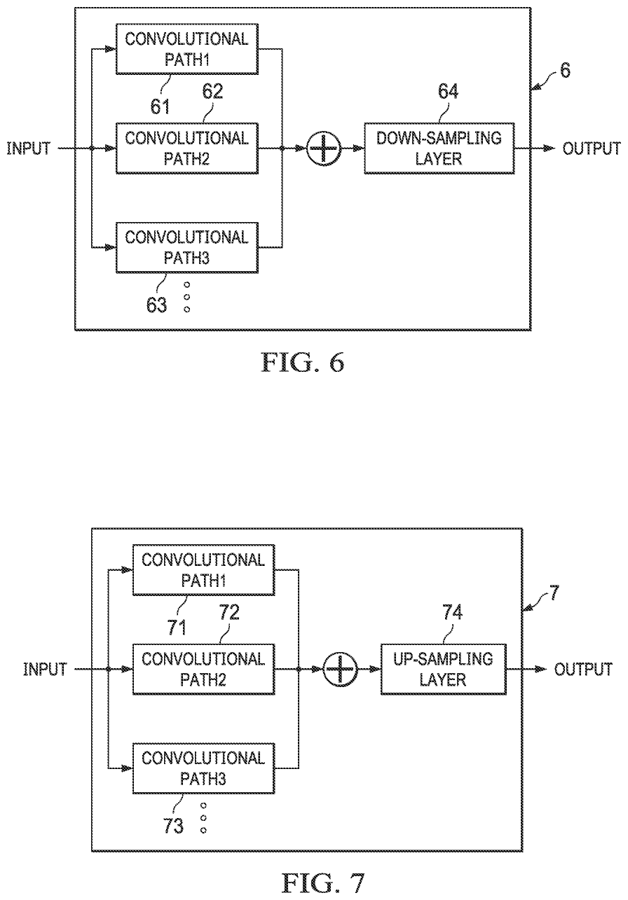

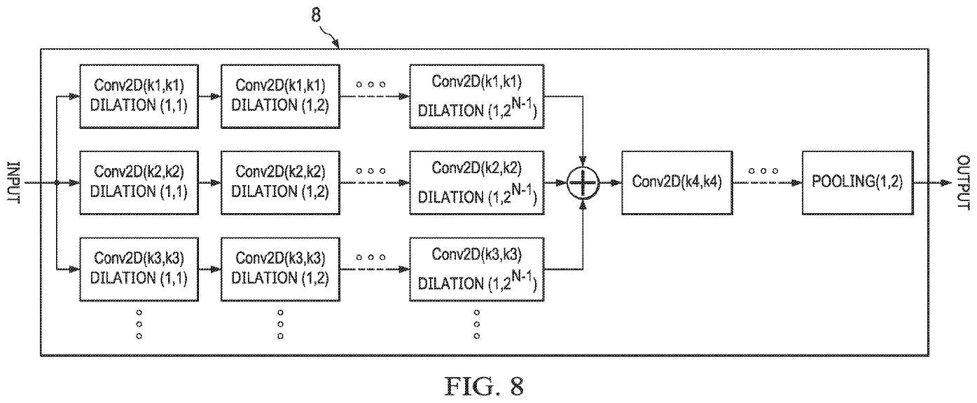

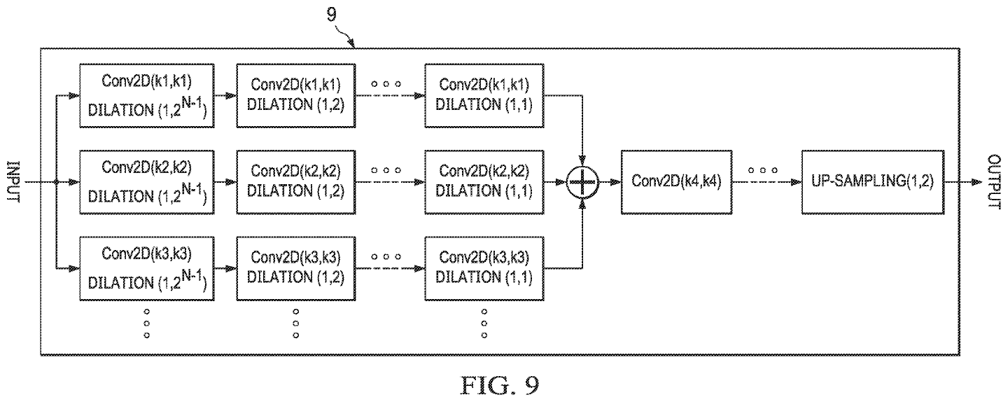

FIG. 5 illustrates a second embodiment of a proposed CNN architecture. The proposed CNN architecture may be implemented by a suitable computing system, as the skilled person will appreciate. In this second embodiment, multi-scale CNNs are embedded in the encoding layers 51, 52, 53 of the contracting path of a U-net as well as in the decoding layers 54, 55, 56 of the expansive path of a U-net. FIG. 6 illustrates an exemplary multi-scale encoding layer 6 which may be embedded in one or more of the encoding layers 51, 52, 53 of the second embodiment in FIG. 5. It comprises three parallel convolutional paths 61, 62, 63, and a down-sampling layer 64. FIG. 7 illustrates an exemplary multi-scale decoding layer which may be embedded in one or more of the decoding layers 54, 55, 56 of the second embodiment in FIG. 5. It comprises three parallel convolutional paths 71, 72, 73, and an up-sampling layer 74. Again, FIGS. 8 and 9 illustrate a more detailed view of the multi-scale CNNs which may be used for speech enhancement. To be more specific, FIG. 8 illustrates a further exemplary multi-scale encoding layer 8, and FIG. 9 illustrates a further exemplary multi-scale decoding layer 9.

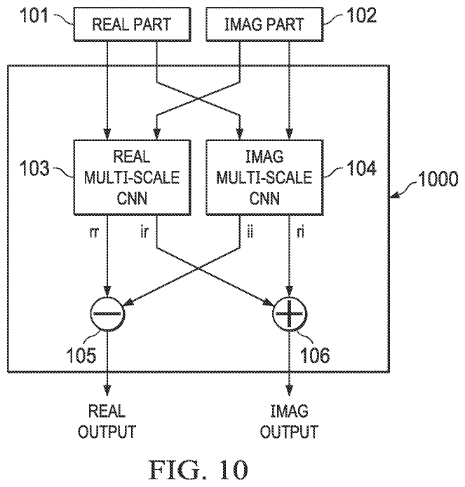

Finally, FIG. 10 illustrates an exemplary complex convolutional layer. Both the first embodiment in FIG. 2 as well as the second embodiment in FIG. 5 may be extended to complex domain processing. In this case, the input would be a complex-valued vector or matrix, such as the complex spectrum of input signals, and the output would be also a complex-valued vector or matrix, such as complex soft mask estimation in the case of speech enhancement application.

One option to achieve this goal is to pack the real and imaginary parts of the input matrix as two input channels, and apply a real-valued convolution operation with one shared real-valued convolution filter. However, this method may be not confined with the complex multiplication rules, and hence the networks may learn the real and imaginary parts independently. To address this issue, the complex convolutional layer shown in FIG. 10 is used. Specifically, the complex convolutional layer models the correlation between magnitude and phase with the simulation of complex multiplication.

In FIG. 10, the exemplary complex convolutional layer 1000 comprises a first CNN 103, a second CNN 105, an adding unit 105, and a subtracting unit 106. The first CNN 103 may be configured to generate a first and a second intermediate representation based on a real part 101 and an imaginary part 102 of an input signal. The second CNN 104 may be configured to generate a third and a fourth intermediate representation based on the real part and the imaginary part of the input signal. The adding unit may be configured to generate a real output representation based on the first and the third intermediate representations. The subtracting unit may be configured generate an imaginary output representation based on the second and the fourth intermediate representations.

The target mask of the complex model is also a complex value and its real and imaginary parts have a quite large value range. Non-linear transformation/compression is usually needed to transform the original value range to a fixed certain range, for example, the range of [0,1]. It would be easier to learn/converge in model training. In this disclosure, we propose two solutions:
(1) limiting the complex target value to be within a unit circle (or other circle with a fixed radius), while keeping the phase the same. In other words, if the absolute value of a complex target is larger than 1, one may limit it to 1. In our earlier experiments, the complex target which has absolute value larger than 1 occupies around 5-10% of all the data points. Capping them to 1 may have only minor impact on the final results.
(2) using a specifically designed attenuation function to shrink the range of the target, such as with a sigmoid function. The inverse function may be applied after the network output to transform the estimate back to the original value range.

The loss function may also include multiples items, i.e. both the real part loss and imaginary part loss for both estimated soft mask and spectrum. It can also include a magnitude loss or wave domain loss by transforming complex value to real value via Inverse Fast Fourier Transformation (IFFT). All the items may be weighted based on a specific application.

### Interpretation

Unless specifically stated otherwise, as apparent from the following discussions, it is appreciated that throughout the disclosure discussions utilizing terms such as “processing,” “computing,” “calculating,” “determining”, “analyzing” or the like, refer to the action and/or processes of a computer or computing system, or similar electronic computing devices, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one example embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The processing system may also encompass a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one or more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code. Furthermore, a computer-readable carrier medium may form, or be included in a computer program product.

In alternative example embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a Personal Digital Assistant (PDA), a cellular telephone, a web appliance, a network router, switch or bridge, or any machine capable of executing a set of instructions (sequential or otherwise) that specify actions to be taken by that machine.

Note that the term “machine” shall also be taken to include any collection of machines that individually or jointly execute a set (or multiple sets) of instructions to perform any one or more of the methodologies discussed herein.

Thus, one example embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, example embodiments of the present disclosure may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present disclosure may take the form of a method, an entirely hardware example embodiment, an entirely software example embodiment or an example embodiment combining software and hardware aspects. Furthermore, the present disclosure may take the form of carrier medium (e.g., a computer program product on a computer-readable storage medium) carrying computer-readable program code embodied in the medium.

The software may further be transmitted or received over a network via a network interface device. While the carrier medium is in an example embodiment a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present disclosure. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media may also take the form of acoustic or light waves, such as those generated during radio wave and infrared data communications. For example, the term “carrier medium” shall accordingly be taken to include, but not be limited to, solid-state memories, a computer product embodied in optical and magnetic media; a medium bearing a propagated signal detectable by at least one processor or one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one example embodiment by an appropriate processor (or processors) of a processing (e.g., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Reference throughout this disclosure to “one example embodiment”, “some example embodiments” or “an example embodiment” means that a particular feature, structure or characteristic described in connection with the example embodiment is included in at least one example embodiment of the present disclosure. Thus, appearances of the phrases “in one example embodiment”, “in some example embodiments” or “in an example embodiment” in various places throughout this disclosure are not necessarily all referring to the same example embodiment. Furthermore, the particular features, structures or characteristics may be combined in any suitable manner, as would be apparent to one of ordinary skill in the art from this disclosure, in one or more example embodiments.

As used herein, unless otherwise specified the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of example embodiments of the disclosure, various features of the disclosure are sometimes grouped together in a single example embodiment, FIG., or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed example embodiment. Thus, the claims following the Description are hereby expressly incorporated into this Description, with each claim standing on its own as a separate example embodiment of this disclosure.

Furthermore, while some example embodiments described herein include some but not other features included in other example embodiments, combinations of features of different example embodiments are meant to be within the scope of the disclosure, and form different example embodiments, as would be understood by those skilled in the art. For example, in the following claims, any of the claimed example embodiments can be used in any combination.

In the description provided herein, numerous specific details are set forth. However, it is understood that example embodiments of the disclosure may be practiced without these specific details. In other instances, well-known methods, structures and techniques have not been shown in detail in order not to obscure an understanding of this description.

Thus, while there has been described what are believed to be the best modes of the disclosure, those skilled in the art will recognize that other and further modifications may be made thereto without departing from the spirit of the disclosure, and it is intended to claim all such changes and modifications as fall within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

Aspects and implementations of the present disclosure will also become apparent from the below enumerated example embodiments (EEEs), which are not claims.

### EEE 1. A Convolutional Neural Network (CNN) Architecture Comprising:

a contracting path of a U-net with a first encoding layer, wherein the contracting path is configured to generate an output representation of the contracting path,
a multi-scale CNN configured to generate, based on the output representation of the contracting path, an intermediate representation, wherein the multi-scale CNN comprises at least two parallel convolution paths,
an expansive path of a U-net with a first decoding layer, wherein the expansive path is configured to generate a final representation based on the intermediate representation generated by the multi-scale CNN.
   EEE 2. The CNN architecture according to EEE 1, wherein the first encoding layer is configured to perform a convolution and a down-sampling operation.
   EEE 3. The CNN architecture according to EEE 1 or 2, wherein the first decoding layer is configured to generate an output by
receiving the intermediate representation generated by the multi-scale CNN,
receiving an output of the first encoding layer,
concatenating the intermediate representation and the output of the first encoding layer,
perform a convolution operation, and
perform an up-sampling operation.
   EEE 4. The CNN architecture according to any one of the preceding EEEs, further comprising a second encoding layer, wherein the second encoding layer is configured to
perform a convolution,
perform a down-sampling operation, and
forward a result to the first encoding layer.
   EEE 5. The CNN architecture according to EEE 4, further comprising a second decoding layer, wherein the second decoding layer is configured to
receive the output of the first decoding layer,
receive an output of the second encoding layer,
concatenate the output of the first decoding layer and the output of the second encoding layer,
performing a convolution operation, and
performing an up-sampling operation.
   EEE 6. The CNN architecture according to any one of the preceding EEEs, wherein the multi-scale CNN is configured to generate an aggregated output based on outputs of the at least two parallel convolution paths.
   EEE 7. The CNN architecture according to EEE 6, wherein the multi-scale CNN is configured to generate the aggregated output by concatenating or adding the outputs of the at least two parallel convolution paths.
   EEE 8. The CNN architecture according to EEE 6 or 7, wherein the multi-scale CNN is configured to weight the outputs of the at least two parallel convolution path using different weights.
   EEE 9. The CNN architecture according to any one of the preceding EEEs, wherein each parallel convolution path of the multi-scale CNN includes L convolution layers, wherein L is a natural number>1, and wherein an 1-th layer among the L layers has N₁ filters with 1=1 . . . L.
   EEE 10. The CNN architecture according to EEE 9, wherein for each parallel convolution path, the number N₁ of filters in the 1-th layer is increasing with increasing layer number 1.
   EEE 11. The CNN architecture according to EEE 9, wherein a filter size of the filters is the same within each parallel convolution path.
   EEE 12. The CNN architecture according to EEE 9, wherein a filter size of the filters is different between different parallel convolution paths.
   EEE 13. The CNN architecture according to EEE 9, wherein, for a given parallel convolution path, the filters of at least one of the layers of the parallel convolution path are dilated 2D convolutional filters.
   EEE 14. The CNN architecture according to EEE 13, wherein the dilation operation of the filters of the at least one of the layers of the parallel convolution path is performed on the frequency axis only.
   EEE 15. The CNN architecture according to EEE 13, wherein, for a given parallel convolution path, the filters of two or more of the layers of the parallel convolution path are dilated 2D convolutional filters, and wherein a dilation factor of the dilated 2D convolutional filters increases exponentially with increasing layer number 1.
   EEE 16. A convolutional neural network (CNN) architecture comprising:
a contracting path of a U-net with a first encoding layer, wherein the contracting path is configured to generate an output representation of the contracting path, wherein the first encoding layer comprises a first multi-scale CNN with at least two parallel convolution paths, and
an expansive path of a U-net with a first decoding layer, wherein the expansive path is configured to generate a final representation based on the output representation of the contracting path, wherein the first decoding layer comprises a second multi-scale CNN with at least two parallel convolution paths.
   EEE 17. The CNN architecture according to EEE 16, further comprising another multi-scale CNN coupled between the contracting path and the expansive path, wherein the another multi-scale CNN
comprises at least two parallel convolution paths, and
is configured to receive and process the output representation of the contracting path.
   EEE 18. The CNN architecture according to EEE 16 or 17, wherein the first multi-scale CNN is configured to
generate an aggregated output based on outputs of the at least two parallel convolution paths,
perform a 2D convolution on the aggregated output, and
perform a down-sampling or pooling operation based on the result of the 2D convolution.
   EEE 19. The CNN architecture according to any one of EEEs 16 to 18, wherein the second multi-scale CNN is configured to
generate an aggregated output based on outputs of the at least two parallel convolution paths,
perform a 2D convolution on the aggregated output, and
perform an up-sampling operation based on the result of the 2D convolution.
   EEE 20. The CNN architecture according to any one of EEEs 16 to 19, wherein the first multi-scale CNN or the second multi-scale CNN comprises a complex convolutional layer with
a first CNN configured to generate a first and a second intermediate representation based on a real part and an imaginary part of an input signal,
a second CNN configured to generate a third and a fourth intermediate representation based on the real part and the imaginary part of the input signal,
an adding unit configured to generate a real output representation based on the first and the third intermediate representations, and
a subtracting unit configured generate an imaginary output representation based on the second and the fourth intermediate representations.
   EEE 21. The CNN architecture according to EEE 20, wherein a complex target range of the complex convolutional layer is limited by disregarding complex target values whose absolute values are larger than a predetermined threshold value.
   EEE 22. The CNN architecture according to EEE 20, wherein a complex target range of the complex convolutional layer is limited by mapping, using a transformation function, complex target values to mapped complex target values whose absolute values are smaller than or equal to a predetermined threshold value.
   EEE 23. An apparatus for audio processing, wherein
the apparatus is configured to receive input of an input audio signal and output an output audio signal,
the apparatus comprises the CNN architecture according to any one of the preceding EEEs, and
an input to the contracting path is based on the input audio signal and the output audio signal is based on an output of the expansive path.
   EEE 24. A method (e.g., computer-implemented method) of audio processing using convolutional neural networks (CNNs), the method comprising
providing a contracting path of a U-net with a first encoding layer,
generating, by the contracting path, an output representation of the contracting path,
providing a multi-scale CNN comprising at least two parallel convolution paths,
generating, by the multi-scale CNN, based on the output representation of the contracting path, an intermediate representation,
providing an expansive path of a U-net with a first decoding layer, and
generating, by the expansive path, a final representation based on the intermediate representation generated by the multi-scale CNN.
   EEE 25. A computer program product comprising a computer-readable storage medium with instructions adapted to cause a device to carry out the method according to EEE 24 when executed by a device having processing capability.
   EEE 26. A method (e.g., computer-implemented method) of audio processing using convolutional neural networks (CNNs), the method comprising
providing a contracting path of a U-net with a first encoding layer, wherein the first encoding layer comprises a first multi-scale CNN with at least two parallel convolution paths,
generating, by the contracting path, an output representation of the contracting path,
providing an expansive path of a U-net with a first decoding layer, wherein the first decoding layer comprises a second multi-scale CNN with at least two parallel convolution paths, and
generating, by the expansive path, a final representation based on the output representation of the contracting path.
   EEE 27. A computer program product comprising a computer-readable storage medium with instructions adapted to cause a device to carry out the method according to EEE 26 when executed by a device having processing capability.
   EEE 28. A system for audio processing, comprising:
one or more processors; and
a non-transitory computer-readable medium storing instructions that, when executed by the one or more processors, cause the one or more processors to perform operations comprising:
   receiving an input audio signal;
processing the input audio signal using a CNN architecture according to any one of EEEs 1 to 22, the processing comprising:
   providing an input to the contracting path of the CNN architecture based on the input audio signal; and
   generating an output audio signal based on an output of the expansive path of the CNN architecture.
      EEE 29. A computing system implementing the CNN architecture according to any one of EEEs 1 to 22.

1. A convolutional neural network (CNN) architecture for audio processing, the CNN architecture comprising:
a contracting path of a U-net with a first encoding layer, wherein the contracting path is configured to generate an output representation of the contracting path based on a first audio signal provided as an input to the contracting path,
a multi-scale CNN configured to generate, based on the output representation of the contracting path, an intermediate representation, wherein the multi-scale CNN comprises at least two parallel convolution paths,
an expansive path of a U-net with a first decoding layer, wherein the expansive path is configured to generate a final representation based on the intermediate representation generated by the multi-scale CNN and to output a second audio signal.

2. The CNN architecture according to claim 1, wherein the first encoding layer is configured to perform a convolution and a down-sampling operation.

3. The CNN architecture according to claim 1,
wherein the first decoding layer is configured to generate an output by
receiving the intermediate representation generated by the multi-scale CNN,
receiving an output of the first encoding layer,
concatenating the intermediate representation and the output of the first encoding layer,
performing a convolution operation, and
performing an up-sampling operation.

4. The CNN architecture according to claim 1, further comprising a second encoding layer, wherein the second encoding layer is configured to
perform a convolution,
perform a down-sampling operation, and
forward a result to the first encoding layer.

5. The CNN architecture according to claim 4, further comprising a second decoding layer, wherein the second decoding layer is configured to
receive the output of the first decoding layer,
receive an output of the second encoding layer,
concatenate the output of the first decoding layer and the output of the second encoding layer,
performing a convolution operation, and
performing an up-sampling operation.

6. The CNN architecture according to claim 1, wherein the multi-scale CNN is configured to generate an aggregated output based on outputs of the at least two parallel convolution paths.

7. The CNN architecture according to claim 6, wherein the multi-scale CNN is configured to:
generate the aggregated output by concatenating or adding the outputs of the at least two parallel convolution paths; and/or
weight the outputs of the at least two parallel convolution path using different weights.

8. (canceled)

9. The CNN architecture according to claim 1, wherein each parallel convolution path of the multi-scale CNN includes L convolution layers, wherein L is a natural number≥1, and wherein an 1-th layer among the L layers has N₁ filters with 1=1 . . . L.

10. The CNN architecture according to claim 9, wherein for each parallel convolution path, the number N₁ of filters in the 1-th layer is increasing with increasing layer number 1.

11. The CNN architecture according to claim 9, wherein a filter size of the filters is:
the same within each parallel convolution path; or
different between different parallel convolution paths.

12. (canceled)

13. The CNN architecture according to claim 9, wherein, for a given parallel convolution path, the filters of at least one of the layers of the parallel convolution path are dilated 2D convolutional filters.

14. The CNN architecture according to claim 13, wherein the dilation operation of the filters of the at least one of the layers of the parallel convolution path is performed on the frequency axis only; or
wherein, for a given parallel convolution path, the filters of two or more of the layers of the parallel convolution path are dilated 2D convolutional filters, and wherein a dilation factor of the dilated 2D convolutional filters increases exponentially with increasing layer number 1.

15. (canceled)

16. A convolutional neural network (CNN) architecture for audio processing, the CNN architecture comprising:
a contracting path of a U-net with a first encoding layer, wherein the contracting path is configured to generate an output representation of the contracting path based on a first audio signal provided as an input to the contracting path, wherein the first encoding layer comprises a first multi-scale CNN with at least two parallel convolution paths, and
an expansive path of a U-net with a first decoding layer, wherein the expansive path is configured to generate a final representation based on the output representation of the contracting path and to output a second audio signal, wherein the first decoding layer comprises a second multi-scale CNN with at least two parallel convolution paths.

17. The CNN architecture according to claim 16, further comprising another multi-scale CNN coupled between the contracting path and the expansive path, and wherein the other multi-scale CNN
comprises at least two parallel convolution paths, and
is configured to receive and process the output representation of the contracting path.

18. The CNN architecture according to claim 16, wherein the first multi-scale CNN is configured to
generate an aggregated output based on outputs of the at least two parallel convolution paths,
perform a 2D convolution on the aggregated output, and
perform a down-sampling or pooling operation based on the result of the 2D convolution; or
wherein the second multi-scale CNN is configured to
generate an aggregated output based on outputs of the at least two parallel convolution paths,
perform a 2D convolution on the aggregated output, and
perform an up-sampling operation based on the result of the 2D convolution.

19. (canceled)

20. The CNN architecture according to claim 16, wherein the first multi-scale CNN or the second multi-scale CNN comprises a complex convolutional layer with
a first CNN configured to generate a first and a second intermediate representation based on a real part and an imaginary part of an input signal,
a second CNN configured to generate a third and a fourth intermediate representation based on the real part and the imaginary part of the input signal,
an adding unit configured to generate a real output representation based on the first and the third intermediate representations, and
a subtracting unit configured generate an imaginary output representation based on the second and the fourth intermediate representations.

21. The CNN architecture according to claim 20, wherein a complex target range of the complex convolutional layer is limited by:
disregarding complex target values whose absolute values are larger than a predetermined threshold value; or
mapping, using a transformation function, complex target values to mapped complex target values whose absolute values are smaller than or equal to a predetermined threshold value.

22. (canceled)

23. An apparatus for audio processing, wherein
the apparatus is configured to receive input of an input audio signal and output an output audio signal,
the apparatus comprises the CNN architecture according to claim 1, and
an input to the contracting path is based on the input audio signal and the output audio signal is based on an output of the expansive path.

24. A method of audio processing using convolutional neural networks (CNNs), the method comprising
providing a contracting path of a U-net with a first encoding layer,
generating, by the contracting path, an output representation of the contracting path,
providing a multi-scale CNN comprising at least two parallel convolution paths,
generating, by the multi-scale CNN, based on the output representation of the contracting path, an intermediate representation,
providing an expansive path of a U-net with a first decoding layer, and
generating, by the expansive path, a final representation based on the intermediate representation generated by the multi-scale CNN.

25. A computer program product comprising a computer-readable storage medium with instructions adapted to cause a device to carry out the method according to claim 24 when executed by a device having processing capability.

26. A method of audio processing using convolutional neural networks (CNNs), the method comprising
providing a contracting path of a U-net with a first encoding layer, wherein the first encoding layer comprises a first multi-scale CNN with at least two parallel convolution paths,
generating, by the contracting path, an output representation of the contracting path,
providing an expansive path of a U-net with a first decoding layer, wherein the first decoding layer comprises a second multi-scale CNN with at least two parallel convolution paths, and
generating, by the expansive path, a final representation based on the output representation of the contracting path.

27. A computer program product comprising a computer-readable storage medium with instructions adapted to cause a device to carry out the method according to claim 26 when executed by a device having processing capability.

28. A system for audio processing, comprising:
one or more processors; and
a non-transitory computer-readable medium storing instructions that, when executed by the one or more processors, cause the one or more processors to perform operations comprising:
receiving an input audio signal;
processing the input audio signal using a CNN architecture according to claim 1, the processing comprising:
providing an input to the contracting path of the CNN architecture based on the input audio signal; and
generating an output audio signal based on an output of the expansive path of the CNN architecture.

29. (canceled)

30. An apparatus for audio processing, wherein
the apparatus is configured to receive input of an input audio signal and output an output audio signal,
the apparatus comprises the CNN architecture according to claim 16, and
an input to the contracting path is based on the input audio signal and the output audio signal is based on an output of the expansive path.

31. A system for audio processing, comprising:
one or more processors; and
a non-transitory computer-readable medium storing instructions that, when executed by the one or more processors, cause the one or more processors to perform operations comprising:
receiving an input audio signal;
processing the input audio signal using a CNN architecture according to claim 16, the processing comprising:
providing an input to the contracting path of the CNN architecture based on the input audio signal; and
generating an output audio signal based on an output of the expansive path of the CNN architecture.
